(19) United States
(12) Patent Application Publication
(10) Pub. No.: US 2023/0068743 A1
(43) Pub. Date: Mar. 2, 2023

(54) MULTI-PHASE COMPOSITION AND METHOD FOR MITIGATING FRACTURING HITS OF UNDERGROUND WELLS

(71) Applicants: Messer Industries USA, Inc., Bridgewater, NJ (US); Nissan Chemical America Corporation, Houston, TX (US)

(72) Inventors: Roberta Watts, Smithville, TX (US); John E. Southwell, Glen Ellyn, IL (US); Yusra K. Ahmad, Franklin Park, NJ (US)

(73) Assignees: Messer Industries USA, Inc., Bridgewater, NJ (US); Nissan Chemical America Corporation, Houston, TX (US)

(21) Appl. No.: 17/794,285

(22) PCT Filed: Jan. 21, 2021
(86) PCT No.: PCT/US21/14266

§ 371 Date: Jul. 21, 2022

Related U.S. Application Data
(60) Provisional application No. 62/965,372, filed on Jan. 24, 2020.

(51) Int. Cl. C09K 8/594; C09K 8/584

(52) U.S. Cl. CPC C09K 8/594; C09K 8/584; C09K 2208/10

(57) ABSTRACT

There is provided a method for mitigating fracturing hits on an underground well consisting of inserting a multi-phase composition comprising gas and a nanoparticle fluid into a pre-existing well for reducing of not eliminating any fracture driven interference at the pre-existing well; and a multi-phase composition for mitigating fracturing hits on an underground well, which consists of a gas and nanoparticle fluid combined to form a well treatment fluid adapted to be injectable into the underground well for resisting fracturing hits on the underground well.

### BACKGROUND

The present invention relates to compositions and methods that use gas compositions to facilitate the recovery of hydrocarbons from underground wells, and to stabilize interactions between a plurality of adjacent wells.

Detrimental interaction or interference among underground wells, or well-to-well interference/interaction, can occur where there is an undesired intersection, pressure or communication between and among separate adjacent wells. Such interactions result from and are associated with fracture driven interactions among the earth and rock which surrounds the wells. These interactions, or so called “Frac Hits”, describe a phenomenon, wherein an existing “Initial” or “Parent” well in a well field is structurally and/or functionally compromised by a newly adjacent “Infill” or “Child” well in the same field and offset from the Parent, whereby a fractured region or zone of the Child well intersects or communicates with a fractured region or zone of the Parent well such that production of one or both of the Parent and Child wells is adversely impacted. In other words, the Frac Hits are fracture driven interference or interactions (FDIs) which result from a new Child well being drilled such that the (FDIs) communicate with a Parent or other existing well to adversely affect production of the Parent or other existing well(s). The distance between a Parent and a Child well, and the distance between adjacent Child wells, may be hundreds of feet to thousands of feet at the closest point. The Frac Hit may include, among other things, an invasion of a fracturing fluid, a stress shadowing effect or formation damage to an existing Parent well from a neighboring Child well which is being fractured. This invasion can negatively impact both the Parent and Child wells. And, it is possible that a Child well may adversely impact other neighboring Child wells with such Frac Hits. The significance of this detrimental impact varies, but is known to cause a reduction in a range of from 60%-100% of the production capacity of the Parent and/or Child wells. The Parent well production is adversely impacted by water from the fractured Child well seeping into or invading the Parent well or damage to the fracturing network of the Parent well. This invasion results in an increase in unwanted water production from the Parent well, and a decrease in hydrocarbon production from the Parent well with little chance of hydrocarbon recovery, all of which is undesirable to oil and gas operators. The Parent and Child wells each may run substantially horizontally underground and may or may not be parallel with each other.

The undesired interference, intersection, communication or invasion (individually and collectively the “Frac Hits”) between the Parent and Child wells can damage each one or both of the wells in one or more ways, and destroy productivity of each. For example, invasion of fracturing fluids from one well into another well; or the phenomenon of “stress shadowing”, wherein stress in the ground or surrounding veins or formations of rock is transmitted to one of more adjacent wells to adversely impact same, will each thereby result in the reduction of both well productivity and the mechanical integrity of the well. These detrimental events can be exacerbated during unconventional drilling operations to maximize hydrocarbon reservoir recovery during, for example, Child well drilling in more densely packed underground shale reservoirs or formations which extend among the Parent and Child wells. This undesirable event is further exacerbated in conditions where the area is reduced between each of the Child and corresponding Parent wells.

The horizontal drilling of a Child well along a shale formation in a region of the Parent well, and the plurality of Child wells to collect the gas and hydrocarbons from the shale layer, increases the structural stress upon the wells. Such stress can further compromise and perhaps collapse the Parent and/or Child wells.

There is accordingly needed cost-effective compositions and related methods to enhance hydrocarbon recovery in existing Parent wells while mitigating Frac Hits upon the Parent wells from the fracturing of the neighboring or related Child wells.

### SUMMARY

There is therefore provided herein a multi-phase composition embodiment of a foam, energized solution or optionally an emulsion embodiment for enhancing hydrocarbon recovery and minimizing Frac Hits in a Parent or other type well, wherein a mixture comprised of a gas selected from the group consisting of carbon dioxide (CO₂) and nitrogen (N₂); and nanoparticles form a foam, an emulsion, or an energized solution for loading into the well to be protected from Frac Hits.

There is also provided herein a method embodiment for enhancing hydrocarbon recovery and minimizing Frac Hits in Parent or other type well, consisting of injecting the components for a multi-phase composition, foam, energized solution or an emulsion comprising the gas and nanoparticles into a Parent well at least before and optionally during a fracturing of a Child well for stabilizing the Parent well.

Other embodiments call for the foam, energized solution or the emulsion to include a gas selected from the group consisting of natural gas, natural gas liquids, liquefied carbon dioxide, and mixtures thereof.

Another embodiment calls for or includes the gas injected before the nanoparticles are injected into the Parent well, after the nanoparticles are injected into the Parent well or concurrent with injection of the nanoparticles into the Parent well at a select location, wherein a total treatment of the foam, energized solution, or emulsion used is held in the well as appropriate until such time as the well can re-opened for production.

Another embodiment calls for the method wherein a treatment fluid may also include one or more injectants selected from the group consisting of surfactants, fresh water, potassium chloride (KCl) water, well-produced water, diverters, and any other injectant used in oil field remediation.

Another embodiment includes a method wherein the treatment fluid comprises gas and colloidal silica nanoparticles.

Another embodiment includes a method wherein the colloidal silica nanoparticles are brine resistant colloidal silica nanoparticles.

Another embodiment includes a method wherein the treatment fluid consists of gas, brine resistant colloidal silica nanoparticles and surfactants; and optionally at least one terpenes.

Another embodiment includes a method wherein the treatment fluid consists of gas and less than 0.1 wt, % nanoparticles.

### BRIEF DESCRIPTION OF THE DRAWINGS

For a more complete understanding of the present embodiments, reference may be had to the following detailed description taken in conjunction with the attached drawing(s), of which:

FIG. 1 shows a plan schematic view of an example of the relationship between a Parent well and a Child well. The solid black line represents a Parent or an existing well, and the black dashed line represents a Child or new well drilled and being prepared for initial fracture stimulation. The smaller hatched lines represent natural fractures in the reservoir rock.

### DETAILED DESCRIPTION

Before explaining the inventive embodiments in detail, it is to be understood that the invention is not limited in its application to the details of construction and arrangement of steps or parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity illustrating the invention and should not be taken as words of limitation. The drawings, if any, are for the purpose of illustrating the invention and are not intended to be to scale.

The term “associate with” or “associating with” as used herein includes, for example, covalent bonding, hydrogen bonding, electrostatic attraction, London forces and Hydrophobic interactions.

The term “foam” as used herein refers to foam quality, such as for example a “95 quality foam” is a foam that is 95% gas and 5% liquid. In a foam, at least 52% of the composition is in the gas phase. That is, foam consists of discontinuous gas bubbles suspended in a liquid.

The term “emulsion” as used herein refers to at least two (2) liquids that are immiscible.

An emulsion is composed of discontinuous droplets of liquid suspended in a second immiscible liquid.

The term “energized solution” as used herein refers to a solution where less than 52% of the solution is in the gas phase.

The term “saturate” or its inflected forms and tenses as used herein refers to filling completely with something that permeates or pervades, or to load to capacity.

Generally, and with respect to the present embodiments, pre-loading of a Parent well with the treatment embodiment of the present invention requires the placement of fluids within the well to some specified volume or pressure. A foam or an emulsion, with foam qualities as much as 98 percent (%), of gases and nanoparticles of the present embodiments are used to minimize the amount of fluids required to be inserted into the well, while also mitigating Frac Hit to a maximum extent possible, all the while enhancing hydrocarbon recovery (oil and natural gas) from the well.

The present embodiments provide an effective mechanism for building a desired pressure barrier or deterrent in the Parent well to minimize or eliminate any fracture driven interaction or FDIs created during the fracturing of the Child or Infill well or wells, and enhancing recovery from the treated Parent well, including recovery from other wells in fluid communication with the treated well.

For hydraulic fracturing to recover hydrocarbons, such as for example oil and natural gas, a well may be drilled from a surface pad vertically downward in a well field for many thousands of feet into the earth to a sub-surface “kick-off” point, wherein the well bore is turned to extend horizontally from the vertical well bore. This kick off point will be the beginning of the Parent well (extending horizontally) in the field. Accordingly, a single field may have a plurality of vertical well bores, the first one of which is the initial vertical bore and from which a Parent well extends horizontally from the kick-off point. Each successive vertical well bore also has a kick-off point, and from each there extends horizontally a Child well in the same field and at a distance of from hundreds of feet to thousands of feet adjacent one or a plurality of adjacent Child wells in the same field. Vertical portions of the Parent and Child wells could be from tens to thousands of feet distant from each other, depending upon the surface pad structure employed and the sub-surface rock structure bored through.

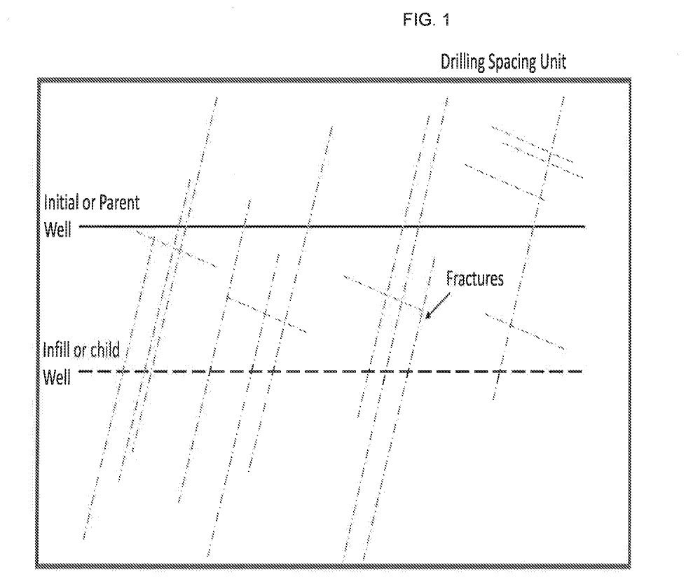

Referring to a single Parent (or “parent”) well and a single Child (or “child”) well as shown in FIG. 1 for the sake of brevity, the child may extend for miles and is usually through the shale reservoir or targeted hydrocarbon formation in the earth, much below the water table.

The child well is lined with a steel pipe, similar to surface casing used in the parent well, and a cement exterior sleeve disposed in the space between an exterior of the steel pipe and the child bore hole.

For parent and child well completion, there are two fracturing techniques. First, a plug and perf is a cased hole completion approach, wherein a bridge plug and perforation (perf) gun are placed in a desired stage within a well bore. With the plug set, the perf gun fires charges to make holes in the casing, thereby penetrating into the rock formation (the “reservoir section”) containing the hydrocarbon between the set plugs. Hydraulic fracturing of the well then takes place, and “frac” fluid is pumped into the section. This process is repeated for each stage of the casing, with the downhole tools moving from a furthest or distal end of the wellbore back toward the beginning or proximate end of the wellbore until all the stages have been fractured. Afterward, the plugs are drilled or milled out for the hydrocarbons to escape back through and out of the well bore for collection at the surface pad. Second, and as an alternative to plug and perf, sliding sleeves may be used to shut off flow from one or more reservoir sections or to regulate pressure between sections during multi-stage frac jobs.

The fractures created from the perforations or “perfs” during the fracturing process provide fluid communication between the shale reservoir containing the hydrocarbons and the child well bore which allows the hydrocarbons to flow from the shale into the child well bore and through same to the vertical portion of the well and out of the well head at the surface for collection and use.

The present method embodiments, and the present foam, energized solution or emulsion embodiments, call for a foam, energized solution or an emulsion to be inserted (via for example injection or other manner of delivery) into the parent well to shore-up same, thereby effectively pressurizing the parent so that same is less likely to be structurally compromised during the Frac Hits from the fracturing of the child well(s). The foam, energized solution or the emulsion is more stable than other known fluids for this type of application and therefore, provides a more uniform and reliable pressure hold in the parent due to the leak-off from the foam, energized solution or the emulsion being slower than would otherwise occur with other known, less viscous liquids, foam, energized solution or an emulsion.

Additionally, the pressure hold may be required in the parent well for as much as two (2) weeks to accommodate the time necessary for the fracturing of a plurality of neighboring child wells emanating from their respective vertical bores and therefore, the foam, energized solution or emulsion is physically better suited for increased residence times than other less viscous liquids for such an extended period of time. The multi-phase composition also minimizes (i) the use of water or other fluids that require a more extensive off-loading of the parent well to get it producing again after the fracturing of the child well or offset wells is completed, ii) any well clean-up process because less fluids require off-loading and the gas phase can energize the removal of excess fluids, and (iii) the possibility of damage from excessive fluid residence time and fluid loading in the parent well.

The following method embodiment can be used to meet the necessary requirement of pressuring-up the parent well, sustaining or maximizing the maintaining of pressure in the parent, optimizing recovery of hydrocarbons out of the parent well, and providing a practical manner by which to execute the present composition and method on a plurality of wells for completion of an infill well drilling program.

The foam, energized solution or the emulsion used in the present embodiments can also include surfactants alone or in combination with the nanoparticles such as colloidal silica nanoparticles, brine resistant colloidal silica nanoparticles, and brine resistant colloidal silica nanoparticles in combination with surfactants and optionally with terpene.

The nanoparticles used in the present embodiments can include inorganic nanoparticles, surface-modified inorganic nanoparticles, organic acid and base surface modification agents for non-silica inorganic nanoparticles, micro emulsions, and micro emulsions comprising nanoparticles/surface-modified nanoparticles.

The present embodiments provide a foam, energized solution or an emulsion of nanoparticles with gas or surface-modified nanoparticles with gas to reduce Frac Hit production interference during oil or hydrocarbon recovery. In certain oil or hydrocarbon recovery methods nanoparticles or surface-modified nanoparticles can act synergistically with surfactant or replace surfactant in reducing interfacial tension between oil or hydrocarbons and aqueous systems. Nanoparticles or surface-modified nanoparticles can also act to remove oil and hydrocarbons from rock surfaces via increased disjoining pressure at the 3-phase contact angle between oil/hydrocarbon—water/brine—rock (for example shale). An appropriate nanoparticle composition and method or a surface-modified nanoparticle composition and method can be used to reduce surface tension of a desired fluid.

In methods where Frac-Hit mitigation strategies are employed it is advantageous to preload a parent well with fluids comprising nanoparticles or surface-modified nanoparticles to take advantage of their tendency to improve oil and hydrocarbon removal for the aforementioned reasons.

The nanoparticle or surface-modified nanoparticle fluids are preferably individual, unassociated (i.e., non-agglomerated) nanoparticles dispersed throughout the dispersing liquid and preferably do not irreversibly associate with each other.

Nanoparticles of interest can be chosen from the following groups: polymers, micro emulsions of dispersed liquids, or inorganic particles. Preferably the nanoparticles are inorganic or micro emulsions of dispersed liquids. Examples of suitable inorganic nanoparticles include colloidal Silica and metal oxide nanoparticles including Zirconia, Titania, Ceria, Alumina or oxides of Aluminum, Iron oxide, Vanadia, oxides of Antimony, oxides of Tin, oxides of Zinc.

In a further embodiment, combinations of inorganic oxides can also be used to make combination nanoparticles such as Alumina modified colloidal Silica, Calcium oxide modified colloidal Silica, Magnesium oxide modified colloidal Silica, and similar colloidal Silica systems modified with oxides of non-silica inorganic oxides.

The nanoparticles used in the present composition and method embodiments may have an average particle diameter of (i) less than 100 nm, (ii) not greater than 50 nm for some applications, and (iii) or from about 3 nm to about 30 nm. If the nanoparticles are aggregated, the maximum cross-sectional dimension of the aggregated particle is within any of the foregoing ranges. Useful surface-modified zirconia nanoparticles include a combination of oleic acid and acrylic acid adsorbed onto the surface of the nanoparticle.

Inorganic nanoparticle fluids can, in a further embodiment, comprise surface-treated nanoparticles. Suitable classes of surface modifying agents include for example organosilanes, organic acids, organic bases, and alcohols. Particularly useful surface modifying agents include organosilanes. Organosilanes, include, but are not limited to, alkylchlorosilanes, alkoxysilanes (e.g. methyltrimethoxysilane, methyltriethoxysilane, ethyltrimethoxysilane, methyltriethoxysilane, n-propyltrimethoxysilane, n-propyltriethoxysilane, isopropyltrimethoxysilane, isopropyltriethoxysilane, butyltrimethoxysilane, butyltriethoxysilane, hexyltrimethoxysilane, octyltrimethoxysilane, 3-mercaptopropyltrimethoxysilane, phenyltrimethoxysilane, glycidoxypropyltrimethoxysilane, methacryloxypropyltrimethoxysilane, methacryloxypropyltriethoxysilane, 3-ethyl-3-oxetanyloxymethylpropyltrimethoxysilane, vinyltrimethoxysilane, vinyldimethylethoxysilane, vinylmethyldiacetoxysilane, vinylmethyldiethoxysilane, vinyltriacetoxysilane, vinyltriethoxysilane, vinyltriisopropoxysilane, vinyltriphenoxysilane, vinyltri(t-butoxy)silane, vinyltris(isobutoxy)silane, vinyltris(isopropenoxy)silane, vinyltris(2-methoxyethoxy)silane, (3-triethoxysilyl)propylsuccinic anhydride, trialkoxyarylsilanes, isooctyltrimethoxysilane, N-(3-triethoxysilylpropyl)methoxyethoxy ethyl carbamate, N-(3triethoxysilylpropyl)methoxyethoxyethoxyethyl carbamate, ureidopropyltrimethoxysilane, 3-acryloyloxypropyltrimethoxysilane; polydialkylsilanes including polydimethylsiloxane; arylsilanes including for example substituted and unsusbstituted arylsilanes; alkylsilanes including for example substituted and unsubstituted alkylsilanes including for examples methoxy and hydroxyl substituted alkylsilanes, and combinations thereof.

Embodiments of nanoparticle fluids comprised of micro emulsions suitable for use in the present embodiments include oil in water microemulsions comprising oil phase, cosolvent phase, surfactant or combination of surfactants, and an aqueous continuous phase. In a further embodiment the microemulsion fluid can itself comprise nanoparticles.

Brine resistant silica sol may be used with the present embodiments, as such includes colloidal silica that has been surface treated in order to resist brine and thereby remain functional and not gelled, even in the presence of significant amounts of salt/brine in the well formation. Brine resistant colloidal silicas may also be used with the present embodiments.

Colloidal silica nanoparticles and brine resistant colloidal silica nanoparticles are commercially available from Nissan Chemical America Corporation.

Brine Resistant Colloidal Silica Nanoparticles in combination with surfactants and optionally in combination with terpenes are commercially available from Nissan Chemical America Corporation under the tradename “nanoActiv® HRT and nanoActiv®EFT”.

Brine resistant colloidal silica is known to be electrostatically stabilized by surface charge, where like charges at the silica particle surface repel the like charges of other particles leading to a stable dispersion—this is part of the definition of a colloidal dispersion. In briny water, where the water/dispersant contains dissolved salt ions, colloidal particles experience a disruption or shielding of particle surface charge leading to a reduction in particle-to-particle repulsion and reduced colloidal stability.

It is known to surface-treat colloidal silica to try to avoid the loss of stability caused when the colloid encounters disruptive conditions, such as brine. However, it is known that some surface treated silica is more brine resistant than others.

With regards to brine resistance of colloidal silica, it is believed without being bound thereby, that the hydrophilicity/hydrophobicity of the surface treatment is important as well as the amount of surface treatment relative to the available silica surface area.

Organic surface treatment can improve colloidal silica stability in brine/high salinity water by addition of steric repulsion properties to supplement electrostatic repulsion between particles. Hydrophilic organic surface treatment is somewhat effective at adding this steric repulsion property for improved brine resistance. A combination of Hydrophilic and Hydrophobic surface treatment in the correct proportion can also form highly brine resistant surface treatment systems for colloidal silica.

Adding some Hydrophobic character to colloidal silica is known in Organic solvent systems. However, it is difficult to achieve in Aqueous systems. In short, Hydrophobic character by definition is water-hating and not prone to solubility or stability in water. It is desirable in this work to add organic surface treatment to colloidal silica having a combination of Hydrophilic and Hydrophobic character—where the silica has both excellent brine stability and the ability to perform well in removing oil from rock surfaces, Combining Hydrophilic and Hydrophobic character is well known in surfactant science but is not well known in organic surface treatment for colloidal silica.

Engineered nanoparticles are expected to reduce the tendency of high molecular weight hydrocarbons such as paraffin and scale to nucleate onto available surfaces and cause a reduction in recovery of desirable hydrocarbons.

### Example(s)

An example of a method embodiment of the present invention calls for inserting a multi-phase composition of a gas and a nanoparticle solution into a pre-existing well for maintaining at least the existing pressure of the pre-existing well and if necessary a pressure slightly higher than the existing pressure; and fracturing at least one secondary well proximate to the pre-existing well; wherein the composition in the pre-existing well substantially reduces if not eliminates fracturing driven interference of the pre-existing well from the fracturing of the at least one secondary well.

Another example of a method embodiment of the present invention includes pressuring a parent well up to 2000-3000 psi prior to fracturing of a child well, and such method includes the following. The parent well, prior to fracturing of a new child well, is initially injected with 3000 gallons of water followed by 300 tons of CO₂. To further build and maximize pressure in the parent, there is used the foaming properties of gas and nanoparticles, i.e. 36,000 gallons of a nanoparticle solution are co-injected with 900 tons of CO₂. This second step may begin either before or during the fracturing of the child well. Depending upon the amount of time necessary to maintain pressure in the parent well, the CO₂ may continue to be injected into the parent after the co-injection step. This pressure hold may be required while another infill (or child) well is fractured.

Other embodiments of the present invention include—

A method for mitigating fracturing hits on an underground well, comprising: inserting a multi-phase composition comprising gas and a nanoparticle fluid into a pre-existing well for reducing if not eliminating any fracture driven interference at the pre-existing well.

A method further comprising: fracturing at least one secondary well in proximity to the pre-existing well; and maintaining structural integrity of the pre-existing well with the multi-phase composition.

The method, wherein the inserting the multi-phase composition is at a time selected from the group consisting of inserting before the fracturing, during the fracturing, and after the fracturing.

The method, wherein the inserting the multi-phase composition comprises injecting the multi-phase composition into the pre-existing well.

The method, wherein the fracturing of at least one secondary well is with hydraulic fracturing.

The method further comprising arranging the at least one secondary well transverse to a longitudinal axis of the pre-existing well.

The method, wherein the gas of the multi-phase composition is inserted into the pre-existing well at a time selected from the group consisting of before the nanoparticle fluid is inserted into the multi-phase composition, after the nanoparticle fluid is inserted into the multi-phase composition, and concurrent with the nanoparticle fluid being inserted into the multi-phase composition.

The method further comprising maintaining the multiphase composition in the pre-existing well for reducing stress fracturing of the pre-existing well; and removing the multi-phase composition from the pre-existing well at a time for resuming recovery of hydrocarbons from the pre-existing well.

The method, wherein the gas is selected from the group consisting of liquefied gas, vaporized gas and nanoparticles, carbon dioxide, nitrogen, natural gas, natural gas liquids, liquefied carbon dioxide, and mixtures thereof.

The method, wherein the multi-phase composition further comprises at least one injectant selected from the group consisting of surfactants, fresh water, potassium chloride (KCl) water, diverters, and any injectant compatible for use in oil field remediation.

The method, wherein the nanoparticle fluid comprises colloidal silica nanoparticles.

The method, wherein the colloidal silica nanoparticles comprise brine resistant colloidal silica nanoparticles.

The method, wherein the nanoparticle fluid comprises brine resistant colloidal silica nanoparticles, and the multi-phase composition further comprises surfactants.

The method, wherein the multi-phase composition further comprises at least one terpene.

The method, wherein the nanoparticle fluid comprises less than 0.1 wt. % of nanoparticles or optionally comprises a range of from 0.05 wt. % to 16 wt. % of nanoparticles.

The method, wherein the pre-existing well comprises an underground bore hole selected from the group consisting of a bore hole positioned below a surface of the earth, and a bore hole positioned beneath a bottom of a body of water.

The method, wherein the body of water is selected from the group consisting of a lake, a sea, an ocean, and a littoral region.

The method further comprising saturating the pre-existing well with the multi-phase composition.

A multi-phase composition for mitigating fracturing hits on an underground well, comprising: a gas and a nanoparticle fluid combined to form a well treatment fluid adapted to be injectable into the underground well for resisting fracturing hits on the underground well.

The multi-phase composition, wherein the gas comprises from 95% to 98% of the well treatment fluid.

The multi-phase composition, wherein the gas is selected from the group consisting of liquefied gas, vaporized gas and nanoparticles, carbon dioxide, nitrogen, natural gas, natural gas liquids, liquefied carbon dioxide, and mixtures thereof.

The multi-phase composition further comprising at least one injectant selected from the group consisting of surfactants, fresh water, potassium chloride (KCl) water, diverters, and any injectant compatible for use in oil field remediation.

The multi-phase composition, wherein the nanoparticle fluid comprises colloidal silica nanoparticles.

The multi-phase composition, wherein the colloidal silica nanoparticles comprise brine resistant colloidal silica nanoparticles.

The multi-phase composition, wherein the nanoparticle fluid comprises brine resistant colloidal silica nanoparticles, and the multi-phase composition further comprises surfactants.

The multi-phase composition further comprising at least one terpene.

The multi-phase composition, wherein the nanoparticle fluid comprises less than 0.1 wt. % of nanoparticles or optionally comprises a range of from 0.05 wt. % to 16 wt. % of nanoparticles.

The multi-phase composition, wherein the well treatment fluid comprises a fluid selected from the group consisting of a foam, an emulsion, and an energized solution.

The multi-phase composition, wherein the well treatment fluid saturates the underground well.

It will be understood that the embodiments described herein are merely exemplary and that a person skilled in the art may make variations and modifications without departing from the spirit and scope of the invention. All such variations and modifications are intended to be included within the scope of the invention as defined herein and in the appended claims, if any. It should also be understood that the embodiments described above are not only in the alternative but can be combined.

What is claimed is:

1. A method for mitigating fracturing hits on an underground well, comprising:
inserting a multi-phase composition comprising gas and a nanoparticle fluid into a pre-existing well for reducing if not eliminating any fracture driven interference at the pre-existing well.

2. The method of claim 1, further comprising:
fracturing at least one secondary well in proximity to the pre-existing well; and
maintaining structural integrity of the pre-existing well with the multi-phase composition.

3. The method of claim 1, wherein the inserting the multi-phase composition is at a time selected from the group consisting of inserting before the fracturing, during the fracturing, and after the fracturing.

4. The method of claim 1, wherein the inserting the multi-phase composition comprises injecting the multi-phase composition into the pre-existing well.

5. The method of claim 2, wherein the fracturing of at least one secondary well is with hydraulic fracturing.

6. The method of claim 2, further comprising arranging the at least one secondary well transverse to a longitudinal axis of the pre-existing well.

7. The method of claim 1, wherein the gas of the multi-phase composition is inserted into the pre-existing well at a time selected from the group consisting of before the nanoparticle fluid is inserted into the multi-phase composition, after the nanoparticle fluid is inserted into the multi-phase composition, and concurrent with the nanoparticle fluid being inserted into the multi-phase composition.

8. The method of claim 1, further comprising maintaining the multiphase composition in the pre-existing well for reducing stress fracturing of the pre-existing well; and removing the multi-phase composition from the pre-existing well at a time for resuming recovery of hydrocarbons from the pre-existing well.

9. The method of claim 1, wherein the gas is selected from the group consisting of liquefied gas, vaporized gas and nanoparticles, carbon dioxide, nitrogen, natural gas, natural gas liquids, liquefied carbon dioxide, and mixtures thereof.

10. The method of claim 1, wherein the multi-phase composition further comprises at least one injectant selected from the group consisting of surfactants, fresh water, potassium chloride (KCl) water, diverters, and any injectant compatible for use in oil field remediation.

11. The method of claim 1, wherein the nanoparticle fluid comprises colloidal silica nanoparticles.

12. The method of claim 11, wherein the colloidal silica nanoparticles comprise brine resistant colloidal silica nanoparticles.

13. The method of claim 1, wherein the nanoparticle fluid comprises brine resistant colloidal silica nanoparticles, and the multi-phase composition further comprises surfactants.

14. The method of claim 13, wherein the multi-phase composition further comprises at least one terpene.

15. The method of claim 1, wherein the nanoparticle fluid comprises less than 0.1 wt. % of nanoparticles or optionally comprises a range of from 0.05 wt. % to 16 wt. % of nanoparticles.

16. The method of claim 1, wherein the pre-existing well comprises an underground bore hole selected from the group consisting of a bore hole positioned below a surface of the earth, and a bore hole positioned beneath a bottom of a body of water.

17. The method of claim 16, wherein the body of water is selected from the group consisting of a lake, a sea, an ocean, and a littoral region.

18. The method of claim 1, further comprising saturating the pre-existing well with the multi-phase composition.

19. A multi-phase composition for mitigating fracturing hits on an underground well, comprising: a gas and a nanoparticle fluid combined to form a well treatment fluid adapted to be injectable into the underground well for resisting fracturing hits on the underground well.

20. The multi-phase composition of claim 19, wherein the gas comprises from 95% to 98% of the well treatment fluid.

21. The multi-phase composition of claim 19, wherein the gas is selected from the group consisting of liquefied gas, vaporized gas and nanoparticles, carbon dioxide, nitrogen, natural gas, natural gas liquids, liquefied carbon dioxide, and mixtures thereof.

22. The multi-phase composition of claim 19, further comprising at least one injectant selected from the group consisting of surfactants, fresh water, potassium chloride (KCl) water, diverters, and any injectant compatible for use in oil field remediation.

23. The multi-phase composition of claim 19, wherein the nanoparticle fluid comprises colloidal silica nanoparticles.

24. The multi-phase composition of claim 23, wherein the colloidal silica nanoparticles comprise brine resistant colloidal silica nanoparticles.

25. The multi-phase composition of claim 19, wherein the nanoparticle fluid comprises brine resistant colloidal silica nanoparticles, and the multi-phase composition further comprises surfactants.

26. The multi-phase composition of claim 25, further comprising at least one terpene.

27. The multi-phase composition of claim 19, wherein the nanoparticle fluid comprises less than 0.1 wt. % of nanoparticles or optionally comprises a range of from 0.05 wt. % to 16 wt. % of nanoparticles.

28. The multi-phase composition of claim 19, wherein the well treatment fluid comprises a fluid selected from the group consisting of a foam, an emulsion, and an energized solution.

29. The multi-phase composition of claim 19, wherein the well treatment fluid saturates the underground well.
